(19) United States
(12) Patent Application Publication
(10) Pub. No.: US 2007/0038881 A1
(43) Pub. Date: Feb. 15, 2007

(54) NETWORK DIAGNOSTIC SYSTEMS AND METHODS FOR ACCESSING STORAGE DEVICES

(75) Inventors: Gayle L. Noble, Boulder Creek, CA (US); Logan Rand Jennings, Menlo Park, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: Finisar Corporation, Sunnyvale, CA (US)

(21) Appl. No.: 11/279,360

(22) Filed: Apr. 11, 2006

Related U.S. Application Data
(63) Continuation-in-part of application No. 11/204,920, filed on Aug. 15, 2005.

(51) Int. Cl. G06F 11/00

(52) U.S. Cl. 714/2

(57) ABSTRACT

A network diagnostic system may include one or more network diagnostic components. A network diagnostic component may include one or more storage devices and may be configured to perform one or more network diagnostic functions. The network diagnostic component and/or at least one other network diagnostic component may access the storage devices to help perform one or more network diagnostic functions and/or to help perform other processes.

### CROSS-REFERENCE TO RELATED APPLICATIONS

This application is a continuation-in-part of U.S. patent application Ser. No. 11/204,920, filed Aug. 15, 2005 and entitled NETWORK DIAGNOSTIC SYSTEMS AND METHODS FOR ACCESSING STORAGE DEVICES, the disclosure of which is incorporated by reference.

### BACKGROUND OF THE INVENTION

1. Field of the Invention

The present invention generally relates to networks and systems for use within a network. More specifically, the present invention relates to network diagnostic systems.

2. Background Technology

Computer and data communications networks continue to proliferate due to declining costs, increasing performance of computer and networking equipment, and increasing demand for communication bandwidth. Communications networks—including wide area networks (“WANs”), local area networks (“LANs”), metropolitan area networks (“MANs”), and storage area networks (“SANS”)—allow increased productivity and use of distributed computers or stations through the sharing of resources, the transfer of voice and data, and the processing of voice, data and related information at the most efficient locations. Moreover, as organizations have recognized the economic benefits of using communications networks, network applications such as electronic mail, voice and data transfer, host access, and shared and distributed databases are increasingly used as a means to increase user productivity. This increased demand, together with the growing number of distributed computing resources, has resulted in a rapid expansion of the number of installed networks.

As the demand for networks has grown, network technology has developed to the point that many different physical configurations presently exist. Examples include Gigabit Ethernet (“GE”), 10 GE, Fiber Distributed Data Interface (“FDDI”), Fibre Channel (“FC”), Synchronous Optical Network (“SONET”) and InfiniBand networks. These networks, and others, typically conform to one of a variety of established standards, or protocols, which set forth rules that govern network access as well as communications between and among the network resources. Typically, such networks utilize different cabling systems, have different characteristic bandwidths and typically transmit data at different speeds. Network bandwidth, in particular, has been the driving consideration behind many advancements in the area of high speed communication systems, methods and devices.

For example, the ever-increasing demand for network bandwidth has resulted in the development of technology that increases the amount of data that can be pushed through a single channel on a network. Advancements in modulation techniques, coding algorithms and error correction have vastly increased the rates at which data can be transmitted across networks. For example, a few years ago, the highest rate that data could travel across a network was at about one Gigabit per second. This rate has increased to the point where data can travel across Ethernet and SONET networks at rates as high as 10 gigabits per second, or faster.

As communication networks have increased in size, speed and complexity however, they have become increasingly likely to develop a variety of problems that, in practice, have proven difficult to diagnose and resolve. Such problems are of particular concern in light of the continuing demand for high levels of network operational reliability and for increased network capacity.

The problems generally experienced in network communications can take a variety of forms and may occur as a result of a variety of different circumstances. Examples of circumstances, conditions and events that may give rise to network communication problems include the transmission of unnecessarily small frames of information, inefficient or incorrect routing of information, improper network configuration and superfluous network traffic, to name just a few. Such problems are aggravated by the fact that networks are continually changing and evolving due to growth, reconfiguration and introduction of new network topologies and protocols. Moreover, new network interconnection devices and software applications are constantly being introduced and implemented. Circumstances such as these highlight the need for effective, reliable, and flexible diagnostic mechanisms.

### SUMMARY

A need therefore exists for a network diagnostic system that reduces the disadvantages and problems listed above and/or other disadvantages and problems. One network diagnostic system may include one or more network diagnostic components. A network diagnostic component may include at least one diagnostic module. The diagnostic module may perform any combination of a variety of network diagnostic functions. Examples of some network diagnostic functions may include a bit error rate tester network diagnostic function, a generator network diagnostic function, a jammer network diagnostic function, a protocol analyzer network diagnostic function, and a monitor network diagnostic function. The diagnostic module may perform network diagnostic functions using network messages received via any combination of a variety of serial protocols, physical layer protocols, and other network protocols. The diagnostic module may be configured to perform network diagnostic functions at or about the line speed of a network from which it receives network messages. However, the diagnostic module may be configured to perform network diagnostic functions at higher or lower speeds—depending on the particular configuration. The network diagnostic component may be embodied as at least a part of any of a variety of systems, such as, a printed circuit board, a blade, a chassis computing system, an appliance, and other similar systems.

Another aspect is a network diagnostic component that may include at least one storage device. The network diagnostic component and/or at least one other network diagnostic component may access the at least one storage device to help perform one or more network diagnostic functions and/or to help perform other processes. For example, the at least one storage device may be accessed to read from and/or to write to at least a portion of the at least one storage device.

Yet another aspect is a network diagnostic component that is configured to compare at least a portion of the contents of a storage device of the network diagnostic component and at least a portion of the contents of at least one storage device of at least one other network diagnostic component.

Still another aspect is a network diagnostic component that is configured to copy at least a portion of the contents of a storage device of the network diagnostic component to at least one storage device of at least one other network diagnostic component.

Another aspect is a network diagnostic component that is configured to perform a first bit sequence capture and to compare at least a portion of the first bit sequence capture and at least a portion of a second bit sequence capture, which may be performed by another network diagnostic component.

Yet another aspect is a network diagnostic method that may be performed by a first network diagnostic component. The method may comprise accessing a storage device of a second network diagnostic component, the second diagnostic component being configured to perform at least one network diagnostic function. In one embodiment, the method may further comprise reading from at least a portion of the first storage device, writing to at least a portion of the first storage device, or both. In one embodiment, the method may further comprise comparing at least a portion of the contents of a storage device of the first network diagnostic component and at least a portion of the contents of the storage device of the second network diagnostic component. In one embodiment, the method may further comprise copying at least a portion of the contents of a storage device of the first network diagnostic component to the storage device of the second network diagnostic component. In one embodiment, the method may further comprise performing a first bit sequence capture; and comparing at least a portion of the first bit sequence capture and at least a portion of a second bit sequence capture performed by the second diagnostic component.

Still another aspect is a network diagnostic system that may comprise a first network diagnostic component configured to perform at least one network diagnostic function, the first network diagnostic component being configured to map to a storage device of a first network accessible component. The first network diagnostic component may access the storage device via a network or other suitable means. In one embodiment, the storage device of the first network accessible component comprises memory. In one embodiment, the first network diagnostic component comprises a protocol analyzer. In one embodiment, the first network diagnostic component forms at least a portion of a printed circuit board.

For purposes of summarizing, some aspects, advantages, and novel features have been described. Of course, it is to be understood that not necessarily all such aspects, advantages, or features will be embodied in any particular embodiment of the invention. Further, embodiments of the invention may comprise aspects, advantages, or features other than those that have been described. Some aspects, advantages, or features of embodiments of the invention may become more fully apparent from the following description and appended claims or may be learned by the practice of embodiments of the invention as set forth in this disclosure.

### BRIEF DESCRIPTION OF THE DRAWINGS

The appended drawings contain figures of preferred embodiments to further clarify the above and other aspects, advantages and features of the present invention. It will be appreciated that these drawings depict only preferred embodiments of the invention and are not intended to limits its scope. The invention will be described and explained with additional specificity and detail through the use of the accompanying drawings in which:

FIG. 1 is a block diagram illustrating an exemplary embodiment of a network diagnostic system;

FIG. 2 is a flowchart illustrating an exemplary embodiment of a network diagnostic method;

FIG. 3 is a flowchart illustrating another exemplary embodiment of a network diagnostic method;

FIG. 4 is a block diagram illustrating another exemplary embodiment of a network diagnostic system;

FIG. 5 is a flowchart illustrating another exemplary embodiment of a network diagnostic method;

FIG. 6 is a flowchart illustrating yet another exemplary embodiment of a network diagnostic method; and

FIG. 7 is a flowchart illustrating still another exemplary embodiment of a network diagnostic method.

### DETAILED DESCRIPTION OF THE PREFERRED EMBODIMENTS

The present invention is generally directed towards a network diagnostic system. The principles of the present invention, however, are not limited to network diagnostic systems. It will be understood that, in light of the present disclosure, the inventions disclosed herein can be successfully used in connection with other types of systems. A detailed description of an exemplary network diagnostic system now follows.

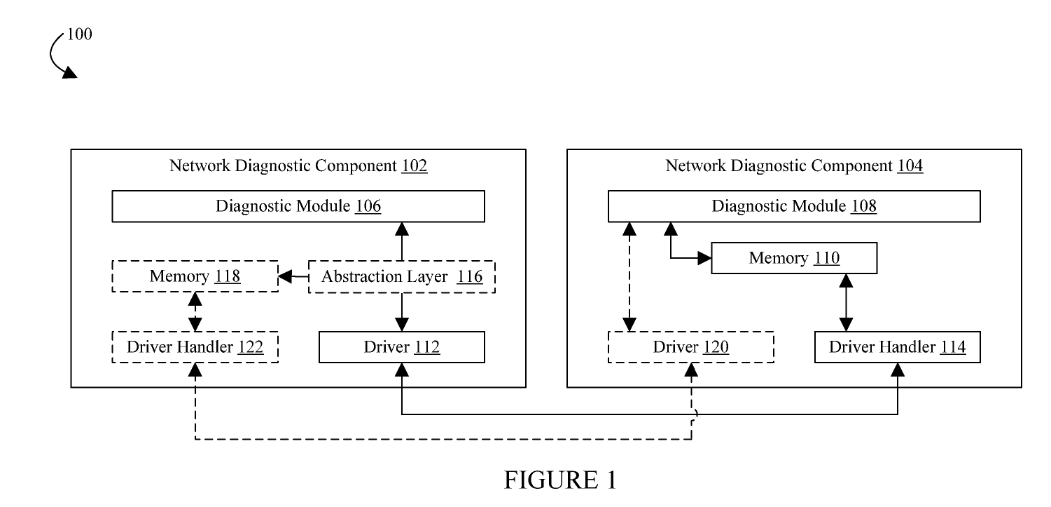

As shown in FIG. 1, a network diagnostic system 100 may include one or more network diagnostic components, such as a network diagnostic component 102 and a network diagnostic component 104. The network diagnostic components 102, 104 may include one or more diagnostic modules. For example, the network diagnostic component 102 may include a diagnostic module 106, and a network diagnostic component 104 may include a diagnostic module 108. The diagnostic modules 106, 108 may perform one or more network diagnostic functions. Exemplary network diagnostic functions include, but are not limited to, network analysis, monitoring, bit error rate testing, generating, jamming, other network diagnostic functions, and the like. In one embodiment, a diagnostic module, such as the diagnostic modules 106, 108, may comprise one or more hardware modules, one or more software modules, or both.

### Exemplary Architecture

To perform one or more network diagnostic functions, a diagnostic module may access or otherwise use one or more storage devices. Further, a plurality of diagnostic modules may share a storage device, if desired. As used herein, “storage device” is a broad term and is used in its ordinary meaning and includes, but is not limited to, a hard disk drive, a tape drive, a redundant array of independent disks (RAID), a floppy disk, a CD-ROM or other optical disk, magnetic disk storage, memory, flash memory, nonvolatile memory (such as, memory with data that remains intact when the power is removed), volatile memory (such as, memory with data that is lost when the power is removed), random access memory (RAM), RAM cache, RAM made using complementary metal oxide semiconductor technology (CMOS RAM), read-only memory (ROM), programmable read-only memory (PROM), erasable programmable read-only memory (EPROM), electrically erasable programmable read-only memory (EEPROM), any other suitable computer-readable medium, any combination thereof, and the like.

For example, the diagnostic module 108 of the network diagnostic component 104 may access or otherwise use the memory 110 of the network diagnostic component 104 to perform one or more network diagnostic functions; and the diagnostic module 106 of the network diagnostic component 102 may also access or otherwise use the memory 110 of the network diagnostic component 104 to perform one or more network diagnostic functions. To access or otherwise use the memory 110, the diagnostic module 106 may use a driver 112, which communicates via a driver handler 114. The diagnostic module 106 may also communicate with the driver 112 via one or more abstraction layers 116.

Also, for example, the diagnostic module 106 of the network diagnostic component 102 may access or otherwise use a memory 118 of the network diagnostic component 102 to perform one or more network diagnostic functions; and the diagnostic module 108 of the network diagnostic component 104 may access or otherwise use the memory 118 of the network diagnostic component 102 to perform one or more network diagnostic functions.

In one embodiment, the diagnostic module 106 may access or otherwise use both the memory 118 and the memory 110 via the abstraction layer 116. For example, the diagnostic module 106 may request an allocation of memory via the abstraction layer 116, and the abstraction layer 116 may choose to allocate the requested amount of memory in the memory 118, in the memory 110, or in both the memory 118 and the memory 110. The diagnostic module 106 may then use the allocated memory (whether allocated in the memory 110, the memory 118, or in both) via the abstraction layer 106. The diagnostic module 106 preferably uses the abstraction layer 116 to request and use memory without the diagnostic module 106 specifically requesting that the memory be local (such as, the memory 118) or remote (such as, the memory 110)—allowing the abstraction layer 116 to decide whether to allocate local memory, remote memory or both in response to the request.

To access or otherwise use the memory 118, the diagnostic module 108 may use a driver 120, which communicates via a driver handler 122. The diagnostic module 108 may also communicate with the driver 120 via one or more abstraction layers (not shown). In one embodiment, the diagnostic module 108 may access or otherwise use both the memory 110 and the memory 110 via an abstraction layer.

Thus, the diagnostic module of a first network diagnostic component may be configured to use a storage device of the first network diagnostic component, a storage device of one or more other network diagnostic components, or a combination thereof to perform one or more network diagnostic functions. It will be appreciated, however, that the diagnostic modules 106, 108 do not require any driver, driver handler, or abstraction layer to access or otherwise use the memory 110, 118, respectively. In fact, the diagnostic modules 106, 108 may use any other suitable means to access or otherwise use the memory 110, 118, respectively.

### Exemplary Methods

As shown above, the diagnostic module of a first network diagnostic component may be configured to use at least one storage device of at least one other network diagnostic component, for example, to perform one or more network diagnostic functions.

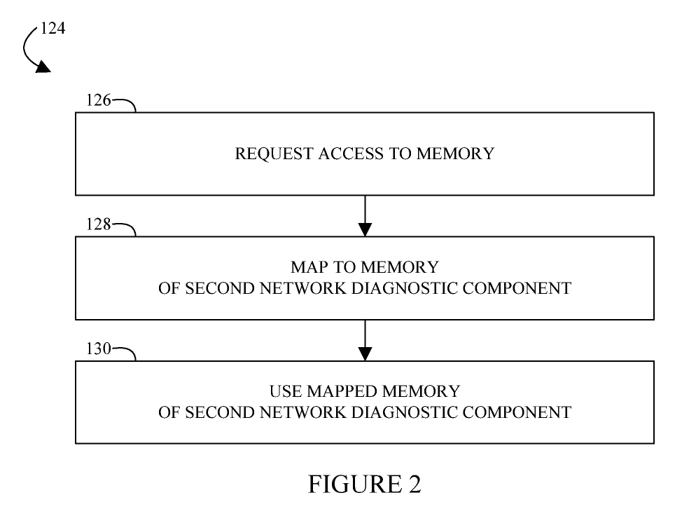

As shown in FIG. 2, the diagnostic module of a network diagnostic component (for example, the diagnostic module 106) preferably performs all or at least a portion of a method 124; however, other suitable modules and/or systems may perform the method 124. Further, all or any suitable portion of the method 124 may be performed to provide a useful method 124. The diagnostic module 106 may request access to a storage device, as represented by block 126. The request may, for example, indicate a particular storage device (such as the memory 110) or generally indicate a type of storage device (such memory in general). The request may also, for example, indicate that the storage device should be allocated or reserved for use. In response to the request, the diagnostic module 106 may map to a storage device of a second network diagnostic component—such as the memory 110 of the network diagnostic component 104—as represented by block 128. The diagnostic module 106 may then use the memory 110 of the network diagnostic component 104 for any suitable purpose, including but not limited to performing one or more network diagnostic functions, as represented by block 130. Exemplary uses include, but are not limited to, reading from the storage device and/or writing to the storage device.

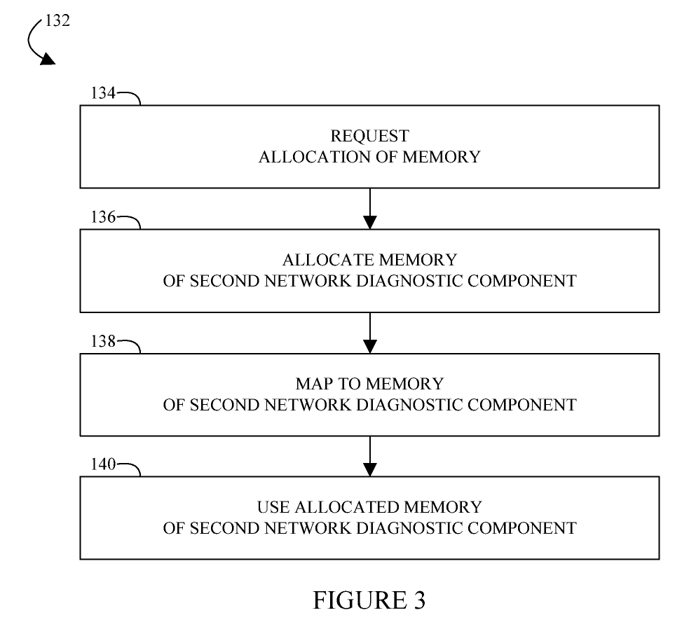

As shown in FIG. 3, the diagnostic module of a network diagnostic component (for example, the diagnostic module 106) preferably performs all or at least a portion of a method 132; however, other suitable modules and/or systems may perform the method 132. Further, all or any suitable portion of the method 132 may be performed to provide a useful method 132.

The diagnostic module 106 may request that at least a portion of a storage device should be allocated or reserved for use, as represented by block 134. The request may, for example, indicate a particular storage device (such as the memory 110) or generally indicate a type of storage device (such memory in general). In response to the request, at least a portion of the storage device of a second network diagnostic component—such as the memory 110 of the network diagnostic component 104—may be allocated, as represented by block 136. For example, as discussed above, the diagnostic module 106 may request an allocation of memory via the abstraction layer 116, and the abstraction layer 116 may choose to allocate the requested amount of memory in the memory 118, in the memory 110, or in both the memory 118 and the memory 110.

The diagnostic module 106 may map to the allocated portion of the memory 110, as represented by block 138. The diagnostic module 106 may use the allocated portion of the memory 110 for any suitable purpose, including but not limited to performing one or more network diagnostic functions, as represented by block 140. For example, as discussed above, the diagnostic module 106 may use the allocated memory (whether allocated in the memory 110, the memory 118, or in both) via the abstraction layer 106.

### Exemplary Architecture

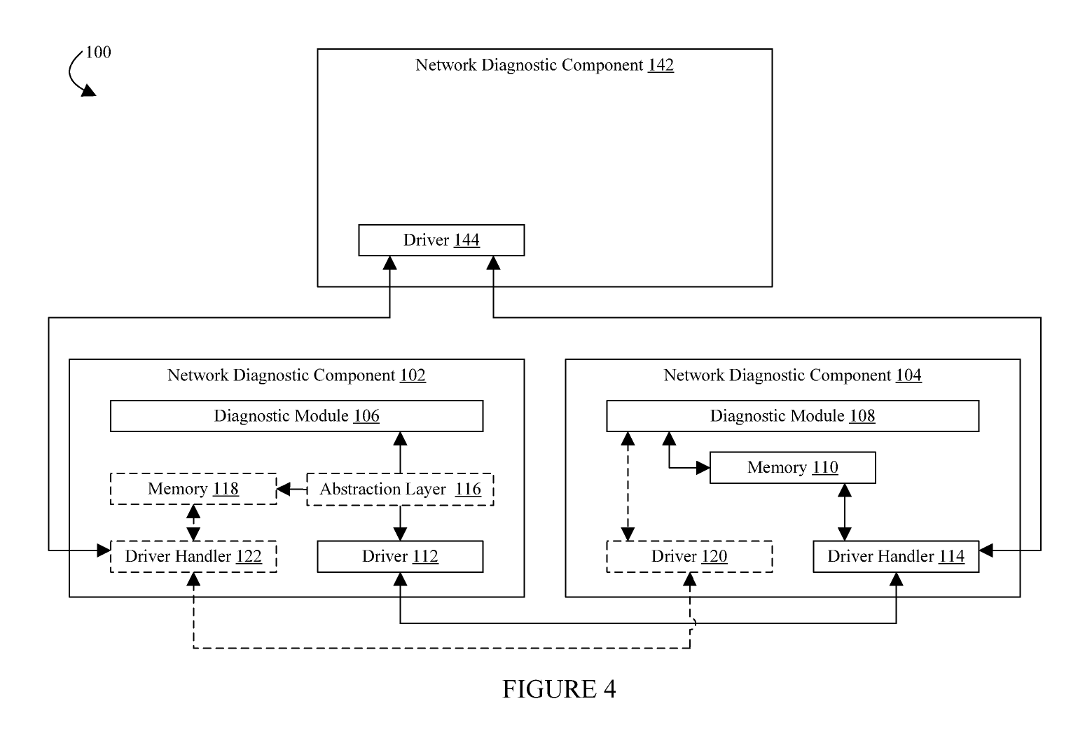

As shown in FIG. 4, the network diagnostic system 100 may include a network diagnostic component 142. The network diagnostic component 142 may include one or more diagnostic modules (not shown), which may be like those diagnostic modules included in the network diagnostic components 102, 104. The network diagnostic component 142 may access or otherwise use the memory 110 of the network diagnostic component 104 and/or the memory 118 of the network diagnostic component 102 to perform one or more network diagnostic functions. To access or otherwise use the memory 110 and/or the memory 118, the network diagnostic component 142 may use a driver 144, which communicates via the driver handlers 120, 122. One or more abstraction layers may be provided for communication via the driver 144, if desired.

### Exemplary Methods

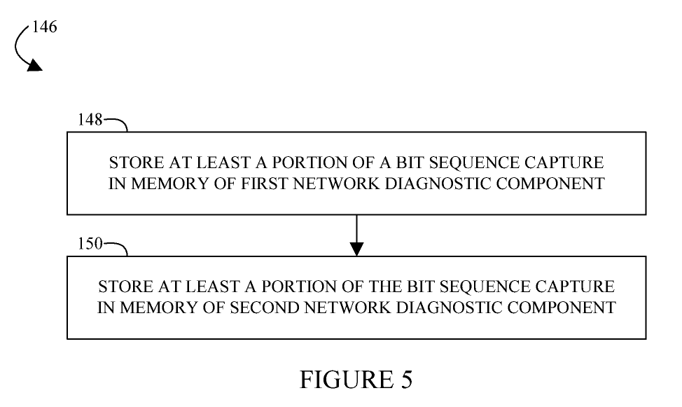

As shown in FIGS. 5-7, the diagnostic module of a network diagnostic component (for example, the diagnostic module of a protocol analyzer) preferably performs all or at least a portion of a method 146, all or at least a portion of a method 152, all or at least a portion of method 160, other suitable methods, or any combination thereof For example, in one embodiment, the network diagnostic component 142 comprises a client software program; the network diagnostic component 102 comprises a first protocol analyzer hardware component; and the network diagnostic component 104 comprises a second protocol analyzer hardware component. In this embodiment, the network diagnostic component 102 may perform all or at least a portion of a method 146, all or at least a portion of a method 152, all or at least a portion of method 160, other suitable methods, or any combination thereof It will be appreciated, however, that the network diagnostic components 102, 104, and 142 may comprise any other combination of suitable network diagnostic components and that other suitable modules and/or systems may perform the methods 146, 152, and 160. Further, all or any suitable portion of the methods 146, 152, and 160 may be performed to provide useful methods 146, 152, and 160.

As shown in FIG. 5, the diagnostic module 106 may store at least a portion of a bit sequence capture in a first storage device, such as the memory 118, as represented by block 148. The diagnostic module 106 may store at least a portion of the bit sequence capture in a second storage device, such as the memory 110, as represented by block 150. The diagnostic module 106 may, of course, access or otherwise use the memory in any manner described above or in any other suitable manner. In one embodiment, the diagnostic module 106 may store a bit sequence capture at block 148 and may store a copy of all or a portion of the bit sequence capture at block 150. In one embodiment, the diagnostic module 106 may store a first portion of a bit sequence capture at block 148 and may store a second, different portion of the bit sequence capture at block 150.

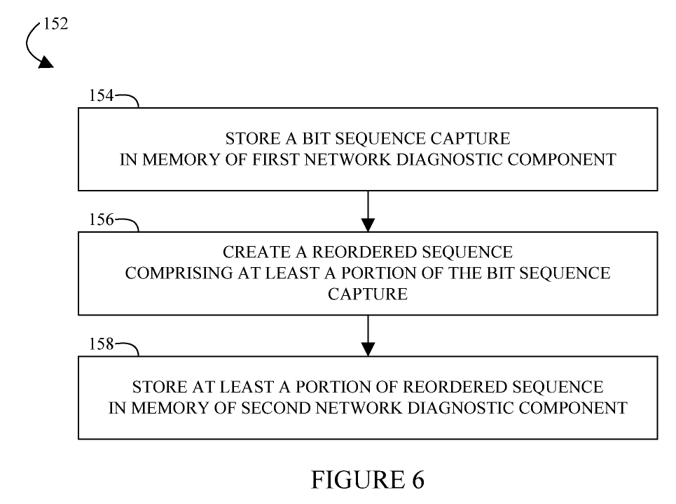

As shown in FIG. 6, the diagnostic module 106 may store a bit sequence capture in a first storage device, such as the memory 118, as represented by block 154. The diagnostic module 106 may also create a reordered sequence including at least a portion of the bit sequence capture, as represented by block 156. For example, in one embodiment, the bit sequence capture may comprise a series of network messages that arrived in a first sequence, order or arrangement; and the reordered sequence may comprise at least some of the those network messages arranged in a second, different sequence, order or arrangement. The diagnostic module 106 may store at least a portion of the reordered sequence in a second storage device, such as the memory 110, as represented by block 158. Accordingly, in one embodiment, the diagnostic module 106 may use the at least a portion of the reordered sequence in the memory 110 to perform one or more network diagnostic functions. Also, in one embodiment, the diagnostic module 108 may use the at least a portion of the reordered sequence in the memory 110 to perform one or more network diagnostic functions. Further, in one embodiment, the network diagnostic component 142 may use the at least a portion of the reordered sequence in the memory 110 to perform one or more network diagnostic functions. It will be appreciated that the network diagnostic component 102, 104 may transmit at least a portion of the reordered sequence from block 156 to the network diagnostic component 142, which the network diagnostic component 142 may use to perform one or more network diagnostic functions. However, any combination of the network diagnostic components 102, 104, 142 may use any combination of storage devices and any portion of the reordered sequence for performing one or more network diagnostic functions.

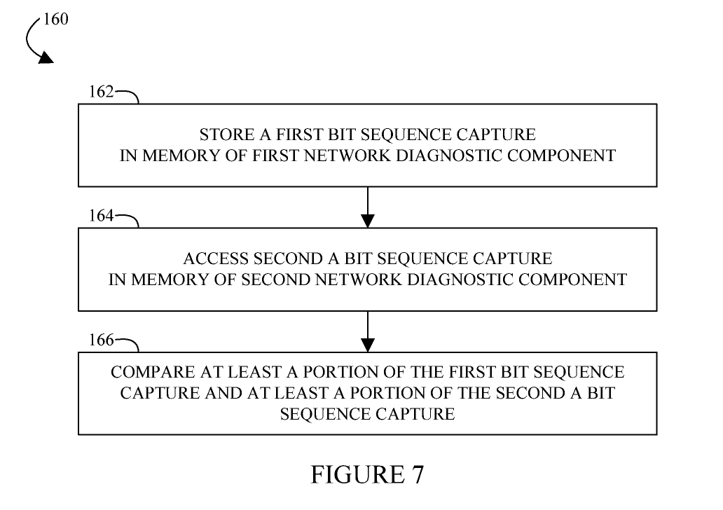

As shown in FIG. 7, the diagnostic module 106 may store a first bit sequence capture in a first storage device, such as the memory 118 of the network diagnostic component 102, as represented by block 162. The diagnostic module 106 may access a second bit sequence capture in a second storage device, such as the memory 110 of the network diagnostic component 104, as represented by block 164. The diagnostic module 106 may compare at least a portion of the first bit sequence capture and at least a portion of the second bit sequence capture, as represented by block 166. In one embodiment, one or more bit masks may be used to facilitate this comparison. Also, in one embodiment, this comparison may comprise a hardware comparison, which may advantageously provide a faster and/or more reliable result. In one embodiment, the diagnostic module 106 may forward the results of the comparison to the network diagnostic module 142, which may then perform further processing.

Some suitable hardware comparisons and related systems and methods are disclosed in U.S. Pat. No. 6,393,587, entitled DEEP TRACE MEMORY SYSTEM FOR A PROTOCOL ANALYZER, which is incorporated by reference herein. It will be appreciated that the comparison may be performed using any other suitable system and/or method.

### Exemplary Components

As discussed above, a network diagnostic component (such as network diagnostic components 102, 104) may access memory (such as memory 110, 118) or other storage devices of one or more other network diagnostic components.

However, if desired, a network diagnostic component may access storage devices of other network diagnostic components and/or any other suitable components. For example, in one embodiment, to perform one or more desired functions, a network diagnostic component may access the storage devices of computers, peripherals, other hardware components, any network accessible components, other components, and/or the like. Also, the network diagnostic component may access these storage devices via a network, a wireless network, and/or any other suitable means.

Further, if desired, any other components may access the storage devices of one or more network diagnostic components. For example, in one embodiment, to perform one or more desired functions, computers, peripherals, other hardware components, any network accessible components, other components, and/or the like may access the storage devices of one or more network diagnostic components via a network, a wireless network, and/or any other suitable means.

Accordingly, if desired, a network diagnostic component may map to one or more storage devices of other network diagnostic components, computers, peripherals, other hardware components, any network accessible components, other components, and/or the like. Further, if desired, computers, peripherals, other hardware components, any network accessible components, other components, and/or the like may map to one or more storage devices of network diagnostic components. For some embodiments, one skilled in the art may leverage mapping technologies—such as drivers, protocols, driver handlers, and/or the like—to aid with mapping various components. Of course, one skilled in the art may use any other suitable technologies to help map various components.

### Exemplary Network Diagnostic Components

In one embodiment, a network diagnostic component may comprise a printed circuit board. The printed circuit board may include at least one CPU module and/or at least one diagnostic module. The CPU module may comprise, for example, a central processing unit, other suitable processors, and the like.

In one embodiment, a network diagnostic component may comprise a blade, which may comprise a printed circuit board. The blade may include at least one interface and/or at least one diagnostic module, which may be coupled to the at least one interface. The interface may be configured, for example, to send and/or receive network diagnostic data or other suitable data with a CPU module or other suitable component.

In one embodiment, a network diagnostic component may comprise a chassis computing system. The chassis computing system may include one or more CPU modules, which may be adapted to interface with one, two, or more blades or other printed circuit boards. For example, a blade may have an interface through which a diagnostic module may send network diagnostic data to the CPU module. The chassis computer system adapted to selectively receive and/or retain one or more printed circuit boards or blades.

A CPU module—such as a CPU module of the chassis computing system or a printed circuit board—may be configured to transmit the network diagnostic data it receives to a local storage device, a remote storage device, or any other suitable system for retrieval and/or further analysis of the diagnostic data. A client software program may retrieve, access, and/or manipulate the diagnostic data for any suitable purpose. Examples of systems and methods for storing and retrieving network diagnostic data include, but are not limited to, those described in U.S. patent application Ser. No. 10/307,272, entitled A SYSTEM AND METHOD FOR NETWORK TRAFFIC AND I/O TRANSACTION MONITORING OF A HIGH SPEED COMMUNICATIONS NETWORK and filed Nov. 27, 2002, which is hereby incorporated by reference herein in its entirety.

In one embodiment, a network diagnostic component may comprise an appliance. Depending on the particular configuration, the appliance may include any suitable combination of one or more CPU modules and one or more diagnostic modules. In one embodiment, an appliance may include and/or be in communication with one or more storage devices, which may advantageously be used for storing any suitable diagnostic data, statistics, and the like. In one embodiment, an appliance may include and/or be in communication with one or more client interface modules—which may advantageously be used for displaying information to a user, receiving user input from a client software program, sending information to a client software program, or any combination thereof The appliance may also include and/or be in communication with one or more display devices (such as, a monitor) adapted to display information, one or more user input devices (such as, a keyboard, a mouse, a touch screen, and the like) adapted to receive user input, or both.

### Exemplary Network Diagnostic Functions

As mentioned above, the diagnostic modules 106, 108 may perform variety of network diagnostic functions. A diagnostic module, such as the diagnostic modules 106, 108, may be configured to function as any combination of: a bit error rate tester, a protocol analyzer, a generator, a jammer, a monitor, and any other appropriate network diagnostic device.

Bit Error Rate Tester

In some embodiments, a diagnostic module, such as the diagnostic modules 106, 108, may function as a bit error rate tester. The bit error rate tester may generate and/or transmit an initial version of a bit sequence via a communication path. If desired, the initial version of the bit sequence may be user selected. The bit error rate tester may also receive a received version of the bit sequence via a communication path.

The bit error rate tester compares the received version of the bit sequence (or at least a portion of the received version) with the initial version of the bit sequence (or at least a portion of the initial version). In performing this comparison, the bit error rate test may determine whether the received version of the bit sequence (or at least a portion of the received version) matches and/or does not match the initial version of the bit sequence (or at least a portion of the initial version). The bit error tester may thus determine any differences between the compared bit sequences and may generate statistics at least partially derived from those differences. Examples of such statistics may include, but are not limited to, the total number of errors (such as, bits that did not match or lost bits), a bit error rate, and the like.

It will be appreciated that a particular protocol specification may require a bit error rate to be less than a specific value. Thus, a manufacturer of physical communication components and connections (such as, optical cables), communication chips, other components used for communicating, and the like may use the bit error rate tester to determine whether their components comply with a protocol specified bit error rate. Also, when communication components are deployed, the bit error tester may be used to identify defects in a deployed physical communication path, which then may be physically inspected.

Protocol Analyzer

In some embodiments, a diagnostic module, such as the diagnostic modules 106, 108, may function as a protocol analyzer (or network analyzer), which may be used to capture data or a bit sequence for further analysis. The analysis of the captured data may, for example, diagnose data transmission faults, data transmission errors, performance errors (known generally as problem conditions), and/or other conditions.

As described below, the protocol analyzer may be configured to receive a bit sequence via one or more communication paths or channels. Typically, the bit sequence comprises one or more network messages, such as, packets, frames, or other protocol adapted network messages. Preferably, the protocol analyzer passively receives the network messages via passive network connections.

The protocol analyzer may be configured to compare the received bit sequence (or at least a portion thereof) with one or more bit sequences or patterns. Before performing this comparison, the protocol analyzer may optionally apply one or more bit masks to the received bit sequence. In performing this comparison, the protocol analyzer may determine whether all or a portion of the received bit sequence (or the bit masked version of the received bit sequence) matches and/or does not match the one or more bit patterns. In one embodiment, the bit patterns and/or the bit masks may be configured such that the bit patterns will (or will not) match with a received bit sequence that comprises a network message having particular characteristics such as, for example, having an unusual network address, having a code violation or character error, having an unusual timestamp, having an incorrect CRC value, indicating a link re initialization, and/or having a variety of other characteristics.

The protocol analyzer may detect a network message having any specified characteristics, which specified characteristics may be user-selected via user input. It will be appreciated that a specified characteristic could be the presence of an attribute or the lack of an attribute. Also, it will be appreciated that the network analyzer may detect a network message having particular characteristics using any other suitable method.

In response to detecting a network message having a set of one or more characteristics, the network analyzer may execute a capture of a bit sequence, which bit sequence may comprise network messages and/or portions of network messages. For example, in one embodiment, when the network analyzer receives a new network message, the network analyzer may buffer, cache, or otherwise store a series of network messages in a circular buffer. Once the circular buffer is filled, the network analyzer may overwrite (or otherwise replace) the oldest network message in the buffer with the newly received network message or messages. When the network analyzer receives a new network message, the network may detect whether the network message has a set of one or more specified characteristics. In response to detecting that the received network message has the one or more specified characteristics, the network analyzer may execute a capture (1) by ceasing to overwrite the buffer (thus capturing one or more network messages prior to detected message), (2) by overwriting at least a portion or percentage of the buffer with one or more newly received messages (thus capturing at least one network message prior to the detected message and at least network one message after the detected message), or (3) by overwriting the entire buffer (thus capturing one or more network messages after the detected message). In one embodiment, a user may specify via user input a percentage of the buffer to store messages before the detected message, a percentage of the buffer to store messages after the detected message, or both. In one embodiment, a protocol analyzer may convert a captured bit stream into another format.

In response to detecting a network message having a set of one or more characteristics, a network analyzer may generate a trigger adapted to initiate a capture of a bit sequence. Also, in response to receiving a trigger adapted to initiate a capture of a bit sequence, a network analyzer may execute a capture of a bit sequence. For example, the network analyzer may be configured to send and/or receive a trigger signal among a plurality of network analyzers. In response to detecting that a received network message has the one or more specified characteristics, a network analyzer may execute a capture and/or send a trigger signal to one or more network analyzers that are configured to execute a capture in response to receiving such a trigger signal. Further embodiments illustrating trigger signals and other capture systems are described in U.S. patent application Ser. No. 10/881,620 filed Jun. 30, 2004 and entitled PROPAGATION OF SIGNALS BETWEEN DEVICES FOR TRIGGERING CAPTURE OF NETWORK DATA, which is incorporated by reference herein.

It will be appreciated that a capture may be triggered in response to detecting any particular circumstance—whether matching a bit sequence and bit pattern, receiving an external trigger signal, detecting a state (such as, when a protocol analyzer's buffer is filled), detecting an event, detecting a multi network message event, detecting the absence of an event, detecting user input, or any other suitable circumstance.

The protocol analyzer may optionally be configured to filter network messages (for example, network messages having or lacking particular characteristics), such as, messages from a particular node, messages to a particular node, messages between or among a plurality of particular nodes, network messages of a particular format or type, messages having a particular type of error, and the like. Accordingly, using one or more bit masks, bit patterns, and the like, the protocol analyzer may be used identify network messages having particular characteristics and determine whether to store or to discard those network messages based at least in part upon those particular characteristics.

The protocol analyzer may optionally be configured to capture a portion of a network message. For example, the protocol analyzer may be configured to store at least a portion of a header portion of a network message, but discard at least a portion of a data payload. Thus, the protocol analyzer may be configured to capture and to discard any suitable portions of a network message.

It will be appreciated that a particular protocol specification may require network messages to have particular characteristics. Thus, a manufacturer of network nodes and the like may use the protocol analyzer to determine whether their goods comply with a protocol. Also, when nodes are deployed, the protocol analyzer may be used to identify defects in a deployed node or in other portions of a deployed network.

Generator

In some embodiments, a diagnostic module, such as the diagnostic modules 106, 108, may function as a generator. The generator may generate and/or transmit a bit sequence via one or more communication paths or channels. Typically, the bit sequence comprises network messages, such as, packets, frames, or other protocol adapted network messages. The network messages may comprise simulated network traffic between nodes on a network. Advantageously, a network administrator may evaluate how the nodes (and/or other nodes on the network) respond to the simulated network traffic. Thus, the network administrator may be able to identify performance deviations and take appropriate measures to help avoid future performance deviations.

Jammer

In some embodiments, the diagnostic modules 106, 108 may function as a jammer. The jammer may receive, generate, and/or transmit one or more bit sequences via one or more communication paths or channels. Typically, the bit sequences comprise network messages (such as, packets, frames, or other protocol adapted network messages) comprising network traffic between nodes on a network. The jammer may be configured as an inline component of the network such that the jammer may receive and retransmit (or otherwise forward) network messages.

Prior to retransmitting the received network messages, the jammer may selectively alter at least a portion of the network traffic, which alterations may introduce protocol errors or other types of errors. Thus, by altering at least a portion of the network traffic, the jammer may generate traffic, which traffic may be used to test a network. For example, a network administrator may then evaluate how the nodes on the network respond to these errors. For example, a network system designer can perform any one of a number of different diagnostic tests to make determinations such as whether a system responded appropriately to incomplete, misplaced, or missing tasks or sequences; how misdirected or confusing frames are treated; and/or how misplaced ordered sets are treated. In some embodiments, the diagnostic modules 106, 108 may include any suitable jamming (or other network diagnostic system or method) disclosed in U.S. Pat. No. 6,268,808 B1 to Iryami et al., entitled HIGH SPEED DATA MODIFICATION SYSTEM AND METHOD, which is incorporated by reference herein.

In one embodiment, to determine which network messages to alter, the jammer may be configured to compare a received bit sequence—such as a network message—(or a portion of the received bit sequence) with one or more bit sequences or patterns. Before performing this comparison, the jammer may optionally apply one or more bit masks to the received bit sequence. In performing this comparison, the jammer may determine whether all or a portion of the received bit sequence (or the bit masked version of the received bit sequence) matches and/or does not match the one or more bit patterns. In one embodiment, the bit patterns and/or the bit masks may be configured such that the bit patterns will (or will not) match with a received bit sequence (or portion thereof) when the received bit sequence comprises a network message from a particular node, a message to a particular node, a network message between or among a plurality of particular nodes, a network message of a particular format or type, and the like. Accordingly, the jammer may be configured to detect a network message having any specified characteristics. Upon detection of the network message having the specified characteristics, the jammer may alter the network message and/or one or more network messages following the network message.

Monitor

In some embodiments, a diagnostic module, such as the diagnostic modules 106, 108, may function as a monitor, which may be used to derive statistics from one or more network messages having particular characteristics, one or more conversations having particular characteristics, and the like.

As described below, the monitor may be configured to receive a bit sequence via one or more communication paths or channels. Typically, the monitor passively receives the network messages via one or more passive network connections.

To determine the network messages and/or the conversations from which statistics should be derived, the monitor may be configured to compare a received a bit sequence—such as a network message—(or a portion of the received bit sequence) with one or more bit sequences or patterns. Before performing this comparison, the monitor may optionally apply one or more bit masks to the received bit sequence. In performing this comparison, the monitor may determine whether all or a portion of the received bit sequence (or the bit masked version of the received bit sequence) matches and/or does not match the one or more bit patterns. In one embodiment, the bit patterns and/or the bit masks may be configured such that the bit patterns will (or will not) match with a received bit sequence (or portion thereof) when the received bit sequence comprises a network message from a particular node, a network message to a particular node, a network message between or among a plurality of particular nodes, a network message of a particular format or type, a network message having a particular error, and the like. Accordingly, the monitor may be configured to detect a network message having any specified characteristics—including but not limited to whether the network message is associated with a particular conversation among nodes.

Upon detecting a network message having specified characteristics, the monitor may create and update table entries to maintain statistics for individual network messages and/or for conversations comprising packets between nodes. For example, a monitor may count the number of physical errors (such as, bit transmission errors, CRC error, and the like), protocol errors (such as, timeouts, missing network messages, retries, out of orders), other error conditions, protocol events (such as, an abort, a buffer is full message), and the like. Also, as an example, the monitor may create conversation specific statistics, such as, the number of packets exchanged in a conversation, the response times associated with the packets exchanged in a conversation, transaction latency, block transfer size, transfer completion status, aggregate throughput, and the like. It will be appreciated that a specified characteristic could be the presence of an attribute or the lack of an attribute.

In some embodiments, the diagnostic module may include any features and/or perform any method described in U.S. patent application Ser. No. 10/769,202, entitled MULTI-PURPOSE NETWORK DIAGNOSTIC MODULES and filed on Jan. 30, 2004, which is incorporated by reference herein.

### Exemplary Operating and Computing Environments

The methods and systems described above can be implemented using software, hardware, or both hardware and software. For example, the software may advantageously be configured to reside on an addressable storage medium and be configured to execute on one or more processors. Thus, software, hardware, or both may include, by way of example, any suitable module, such as software components, object-oriented software components, class components and task components, processes, functions, attributes, procedures, subroutines, segments of program code, drivers, firmware, microcode, circuitry, data, databases, data structures, tables, arrays, variables, field programmable gate arrays (“FPGA”), a field programmable logic arrays (“FPLAs”), a programmable logic array (“PLAs”), any programmable logic device, application-specific integrated circuits (“ASICs”), controllers, computers, and firmware to implement those methods and systems described above. The functionality provided for in the software, hardware, or both may be combined into fewer components or further separated into additional components. Additionally, the components may advantageously be implemented to execute on one or more computing devices. As used herein, “computing device” is a broad term and is used in its ordinary meaning and includes, but is not limited to, devices such as, personal computers, desktop computers, laptop computers, palmtop computers, a general purpose computer, a special purpose computer, mobile telephones, personal digital assistants (PDAs), Internet terminals, multi-processor systems, hand-held computing devices, portable computing devices, microprocessor-based consumer electronics, programmable consumer electronics, network PCs, minicomputers, mainframe computers, computing devices that may generate data, computing devices that may have the need for storing data, and the like.

Also, one or more software modules, one or more hardware modules, or both may comprise a means for performing some or all of any of the methods described herein. Further, one or more software modules, one or more hardware modules, or both may comprise a means for implementing any other functionality or features described herein.

Embodiments within the scope of the present invention also include computer-readable media for carrying or having computer-executable instructions or data structures stored thereon. Such computer-readable media can be any available media that can be accessed by a computing device. By way of example, and not limitation, such computer-readable media can comprise any storage device or any other medium which can be used to carry or store desired program code means in the form of computer-executable instructions or data structures and which can be accessed by a computing device.

When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a computing device to perform a certain function or group of functions. Data structures include, for example, data frames, data packets, or other defined or formatted sets of data having fields that contain information that facilitates the performance of useful methods and operations. Computer-executable instructions and data structures can be stored or transmitted on computer-readable media, including the examples presented above.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A network diagnostic system comprising:
a first network diagnostic component configured to perform at least one network diagnostic function, the first network diagnostic component including a first storage device; and
a second network diagnostic component configured to perform at least one network diagnostic function, the second network diagnostic component including a second storage device, the second network diagnostic component being configured to access the first and second storage devices via an abstraction layer.

2. The network diagnostic system as in claim 1, wherein the first storage device comprises memory.

3. The network diagnostic system as in claim 1, wherein the first network diagnostic component comprises a protocol analyzer.

4. The network diagnostic system as in claim 1, wherein the first network diagnostic component comprises a first protocol analyzer and wherein the second network diagnostic component comprises a second protocol analyzer.

5. The network diagnostic system as in claim 1, wherein the first network diagnostic component forms at least a portion of a printed circuit board and wherein the second network diagnostic component forms at least a portion of a printed circuit board.

6. The network diagnostic system as in claim 1, wherein the second network diagnostic component is configured to read from at least a portion of the first storage device via the abstraction layer.

7. The network diagnostic system as in claim 1, wherein the second network diagnostic component is configured to write to at least a portion of the first storage device via the abstraction layer.

8. The network diagnostic system as in claim 1, wherein the second network diagnostic component is configured to compare at least a portion of the contents of the first storage device and at least a portion of the contents of the second storage device.

9. The network diagnostic system as in claim 1, wherein the second network diagnostic component is configured to copy at least a portion of the contents of the second storage device to the first storage device.

10. The network diagnostic system as in claim 1, wherein the first network diagnostic component is configured to perform a first bit sequence capture; wherein the second network diagnostic component is configured to perform a second bit sequence capture; and wherein the second network diagnostic component is configured to compare at least a portion of the first bit sequence capture and at least a portion of the second bit sequence capture.

11. A network diagnostic system comprising:
a first network diagnostic component configured to perform at least one network diagnostic function, the first network diagnostic component including a storage device, the first network diagnostic component being configured to access the storage device of the first network diagnostic component and a storage device of a second network diagnostic component via an abstraction layer, the second diagnostic component being configured to perform at least one network diagnostic function.

12. The network diagnostic system as in claim 11, wherein the storage device of the second network diagnostic component comprises memory.

13. The network diagnostic system as in claim 11, wherein the first network diagnostic component comprises a protocol analyzer.

14. The network diagnostic system as in claim 11, wherein the first network diagnostic component comprises a first protocol analyzer and wherein the second network diagnostic component comprises a second protocol analyzer.

15. The network diagnostic system as in claim 11, wherein the first network diagnostic component forms at least a portion of a printed circuit board and wherein the second network diagnostic component forms at least a portion of a printed circuit board.

16. A network diagnostic system comprising:
a network accessible component including a storage device, the network accessible component being configured to permit a network diagnostic component to map to the storage device, the network diagnostic component being configured to perform at least one network diagnostic function.

17. The network diagnostic system as in claim 16, wherein the storage device of the network accessible component comprises memory.

18. The network diagnostic system as in claim 16, wherein the network accessible component comprises a protocol analyzer.

19. The network diagnostic system as in claim 16, wherein the network accessible component comprises a first protocol analyzer and wherein the network diagnostic component comprises a second protocol analyzer.

20. The network diagnostic system as in claim 16, wherein the network accessible component forms at least a portion of a printed circuit board and wherein the network diagnostic component forms at least a portion of a printed circuit board.
